(19) United States
(12) Patent Application Publication
(10) Pub. No.: US 2009/0055238 A1
(43) Pub. Date: Feb. 26, 2009

(54) Meeting optimizer

(76) Inventors: Yuliy Baryshnikov, New York, NY (US); Paulo A. Santos, Morganville, NJ (US); Heather Vaughn, Oakhurst, NJ (US); Qiong Wang, Millington, NJ (US)

Correspondence Address: Lucent Technologies Inc.;Docket Administrator, Room 2F-192, 600-700 Mountain Avenue, Murray Hill, NJ, 07974-0636, US

(21) Appl. No.: 11/895,477

(22) Filed: Aug. 24, 2007

(51) Int. Cl. G06Q 10/00

(52) U.S. Cl. 705/8

(57) ABSTRACT

A meeting location that is “fair” to all the participants may be selected based on at least the travel circumstances and at least two initial criteria by which an optimal meeting location will be selected, at least one of which has values that are determined for each respective one of the meeting participants using at least information derived from the travel circumstances. Note that by “fair” it is generally intended that no participant can reduce his burden without significantly increasing the burden of some other participant. The meeting location may be determined using a multi-criterial approach. A criterion in this context is a particular property of the travel pertaining to a particular user. In the multi-criterial approach, one selects a preference relation based on each of the individual criteria, and the set of non-dominated alternatives is the outcome of the optimization process.

### TECHNICAL FIELD

This invention relates to setting up in-person meetings.

### BACKGROUND OF THE INVENTION

It is well known that when people from various locations want to meet that they often look for a location that is centrally located between the participants, where the centrality may be weighted. See for example U.S. Pat. No. 7,027,995 issued to Kaufman et al. on Apr. 11, 2006, which is incorporated by reference as if set forth fully herein.

### SUMMARY OF THE INVENTION

We have recognized that oftentimes such a central location is not really optimally located when the real world conditions, i.e., the travel circumstances, faced by each participant that must get to the location is considered. For example, although the “as the crow flies” distances may be similar between the starting location of all participants who are driving and the central location, the time for each driving participant to travel to the meeting location may be different depending on the actual distance that needs to be traveled, the speed limits for the roads to be traveled, the number of stop lights and stop signs encountered along the route, etc. Note, too, that this assumes no unanticipated traffic backups or slowdowns. For example, when the meeting is between two people, the first living 20 miles away from the meeting location following a route along a major highway, while the second similarly lives 20 miles away but there are only small local roads along the route between his location and the meeting location, it could take the second person three times as long to travel to the meeting location as it does the first person. Of course, the problem of finding the central location is compounded when 1) there are more than two people that must meet and each person starts their travel to the meeting from a different location and 2) the people are not familiar with the area.

A further complication may arise based on the transportation modes available to the meeting participants. For example, one participant may only have access to walking and public transportation, another participant may have an automobile, a third participant may have a bicycle.

Also, it may be that the participants can afford to allocate only so much time to travel to the meeting. For example, one participant may have an earlier meeting that is scheduled to end at a time that leaves a limited amount of time that is useable for travel before the meeting is scheduled to start. More specifically, one participant may have an earlier meeting that ends at 10:30 A.M., leaving her only a half an hour to travel to a meeting that is desired to be started at 11 A.M.

There may also be other personal or social considerations that need to be taken into account. For example, a participant may only be willing or able to drive a particular amount of time in the dark. Also, the particular costs for traveling, and perhaps which of the participants can better bear the cost, should be considered as well.

The foregoing difficulties may be alleviated, and a meeting location that is “fair” to all the participants may be selected, by a system that receives requests for a meeting for at least two participants and which automatically determines at least one candidate meeting location based on a) at least the travel circumstances, which includes 1) prescribed information that characterizes the participants and 2) information about the traveling environment for the participants, and b) at least two initial criteria by which an optimal meeting location will be selected, at least one of which has values that are determined for each respective one of the meeting participants using at least information derived from the travel circumstances. Note that by “fair” it is generally intended that no participant can reduce his burden without significantly increasing the burden of some other participant, i.e., beyond a prescribed threshold. The prescribed information for each of the participants may include a) starting travel location, b) available travel time, c) available modes of transportation, and d) social or personal limitations of the participant. Information about the traveling environment includes a) time to travel between the starting location and the meeting location, which may determined by employing estimated travel speeds, which in turn may be a function of traffic, weather conditions, road speeds, traffic control devices, and the like, and scheduled transportation routes; b) costs, e.g., cost per mile for car transportation, tolls, public transit fare, airfare, and the like. The criteria by which an optimal meeting location will be selected may be at least one of, for example, a maximum travel time for one or more participants, total travel time by all participants, total distance traveled by all participants, the maximum distance traveled by any single participant, the financial expenses incurred to get the participants to the location, or the like.

One of the at least two initial criteria based on which an optimal meeting location will be selected that need not be based on information derived from the travel circumstances of any meeting participant is the venue for the hosting the meeting. In this regard, note that the particular meeting location selected may depend on the appropriateness of the venue at a particular location to host the meeting. This in turn may depend on the nature of the participants and the nature of the meeting. For example, for a small gathering of friends, a quiet restaurant may be an appropriate venue. On the other hand, for a department meeting of a business, a hotel conference room might be an appropriate venue. For a group of teenagers, a park, beach, or the house of one of the participants might be an appropriate venue.

In the event that unanticipated conditions arise as one or more of the participants are traveling to the meeting, the system may be employed to automatically select an alternative location for the meeting that has become “fairer” than the originally selected meeting location and present it for approval by the participants. One such unanticipated condition may be where one of the intended participants can no longer attend the meeting. Another possible unanticipated condition may be severe traffic congestion, e.g., due to a traffic accident.

In accordance with an aspect of the invention, the problem of determining the meeting location may be solved using a multi-criterial approach that may explicitly take into account the fact that a) each user may have several criteria of interest, which are often conflicting just for that user, such as time to travel and cost of travel; and b) the criteria of different users are typically conflicting on the part of the optimization domain situated “between” the users. A criterion in this context is a particular property of the travel pertaining to a particular user. For example, the time to travel for meeting participant A is one criterion, the time to travel for meeting participant B is a second criterion, the cost of travel for meeting participant A is a third criterion and the cost of travel for meeting participant B is a fourth criterion. Particular criteria of interest, if any, are set for each meeting participant and they need not be the same for each meeting participant. For example, one meeting participant may specify a criterion of interest to him is cost, and in particular, a desire to minimize cost, and no other criterion is of interest. A second meeting participant may have multiple criteria of interest, e.g., the travel time and the cost of travel. Optionally, each user may specify how interested he is in any criterion by assigning it a weight.

In the multi-criterial approach, one selects a preference relation based on each of the individual criteria, and the set of non-dominated alternatives is the outcome of the optimization process that provides suitable choices of meeting locations to the user. Advantageously, additional flexibility is provided by taking into account the conflicting character of the criteria, since it is not necessary to aggregate all the criteria into a single optimization function. Further advantageously, the result of the optimization procedure is intrinsically a set, rather than a single element. Thus, unlike selecting several best ranked variants with respect to optimization of a single functional, the set of non-dominated variants reflects the available range of alternatives that fairly accommodate the conflicting criteria.

### BRIEF DESCRIPTION OF THE DRAWING

In the drawing:

FIG. 1 shows an exemplary page that can be used by a user to set various parameters regarding a meeting request; and

FIG. 2 shows a flowchart representing an exemplary process for selecting a meeting location that is “fair” to all the participants in accordance with the invention shows.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

In the description, identically numbered components within different ones of the FIGs. refer to the same components.

A meeting location that is “fair” to all the participants may be selected, by a system that receives requests for a meeting for at least two participants and which automatically determines at least one candidate meeting location based on at least 1) prescribed information that characterizes the participants and 2) information about the traveling environment for the participants, and b) at least two initial criteria by which an optimal meeting location will be selected, at least one of which has values that are determined for each respective one of the meeting participants using at least information derived from the travel circumstances. Note that by “fair” it is generally intended that no participant can reduce his burden without significantly increasing the burden of some other participant, i.e., beyond a prescribed threshold. The prescribed information for each of the participants may include a) starting travel location, b) available travel time, c) available modes of transportation, and d) social or personal limitations of the participant. Information about the traveling environment includes a) time to travel between the starting location and the meeting location, which may determined by employing estimated travel speeds, which in turn may be a function of traffic, weather conditions, road speeds, traffic control devices, and the like, and scheduled transportation routes; b) costs, e.g., cost per mile for car transportation, tolls, public transit fare, airfare, and the like.

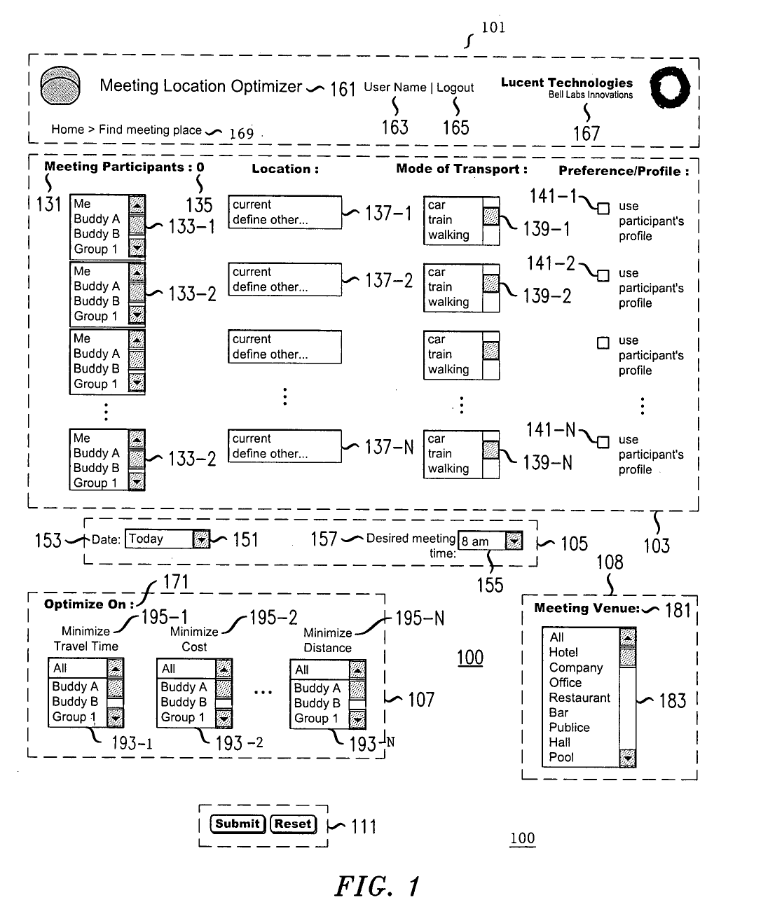

FIG. 1 shows exemplary page 100, e.g., a worldwide-web-type page in hypertext markup language, displayable, e.g., using a so called “browser”, on an electronic screen, e.g., on the display of a personal computer, that can be used by a user to set various parameters regarding a meeting request. The page may be displayed as part of 1) a contacts list manager, 2) special software provided by a service provider, or 3) other software. As shown, page 100 has various areas, including a) header 101, b) meeting participant selection area 103, c) meeting time specification area 105, d) optimization options section 107, e) optional meeting venue section 108, and f) acceptance area 111.

Header section 101 displays to the user certain basic information identifying the overall page that that the user has reached. Thus, header section 101 displays in label 161 that page 100 is part of the “Meeting Location Optimizer”. Label 163 indicates the user name of the particular account that is active, which typically should be the user's account name. Logout hypertext link 165 is a link to bring the user to a logout screen so that the user may logout, e.g., for security reasons or to enable management of a different user account, possibly by a different user sharing the device displaying page 100. Such logout hypertext links are conventional and are known by those of ordinary skill in the art. Field 167 indicates the provider of the software, e.g., Lucent Technologies. Navigation location indication 169 informs the user as to where in the software the user is currently working. In the example shown in FIG. 1, the user is working in the find meeting place part of the software.

Meeting participant selection area 103 provides a way for a user to specify the participants for a meeting, as indicated by label 131, as well as various information about, and possibly criteria of interest to, the participants. To this end, fields 133, including fields 133-1 through 133-N, are selection boxes, typically so-called multi-selection boxes, indicating the names of various individuals who are potential meeting participants and for whom at least some information has already been provisioned, e.g., their names. The user may choose from the displayed choices of individuals and/or predefined groups. Multiple ones of the available choices may be selected from a particular one of fields 133 if they are traveling together and have the same criteria of interest, e.g., they originating their trip to the meeting from the same location and are employing the same mode of transportation. The foregoing conditions are generally assumed to apply as well to each of the underlying members of any listed group.

To select the various meeting participants through the use of fields 133, each of which is a conventional selection box, the user “clicks” on name of a potential meeting participant listed in field 133, e.g., using a pointing device, such as a mouse or a stylus, e.g., for a personal digital assistant (PDA) or tablet personal computer (PC), the name becomes highlighted, e.g., filled, as shown in FIG. 1. In the even that the user utilizes all of the currently displayed fields 133, an additional one may be created and displayed, pushing down what is displayed underneath. The total number of meeting participants that are currently selected is displayed in meeting participants indicator 135.

The user may also indicate the expected origination location for the meeting participants selected in each of fields 133 by employing the corresponding, associated one of location fields 137, which includes location fields 137-1 through 137-N. The meeting participant's location may be selected from choices that typically include any location known to, or computable by, the system or a location expressly entered for that user. The location entered should be the location from which it is believed that the meeting participant will be leaving from when heading to the meeting.

A meeting participant's current location may be chosen should one believe it is valid to make the assumption that the meeting participant will indeed be at the current location at the time he departs for the meeting. For example, if a secretary is setting up the meeting for the following day, and one of the participants is his supervisor who is currently in her office, and it is expected that on the following day the supervisor will likewise be in her office prior to departing for the meeting, selecting her current location simply and appropriately defines the location from which she will start her trip to the meeting. The current location may be obtained or have been previously registered with the system, e.g., using a global positioning system (GPS)-based system. In one exemplary embodiment of the invention, once current location is selected for a meeting participant, the system changes the display in the respectively corresponding location field 137 to an indication of that actual location.

Alternatively, the user may enter a particular location for a meeting participant, e.g., by selecting “define other” from the corresponding location field 137, which will bring a dialog box into which the appropriate location information may be entered. As yet another alternative, information about the meeting participant's location prior to the meeting may be determined based on information stored in his calendar, which is accessed by the system. The last known location prior to the meeting time is employed as the expected departure location.

For each location specified by one of location fields 137, an expected method of transportation for the users departing from that location may be specified within meeting participant selection area 103 by employing the respectively corresponding one of mode of transport fields 139, which include mode of transport fields 139-1 through mode of transport fields 139-N. Only one method of transportation may be employed for each one location fields 137 employed. Exemplary methods of transportation include car, train, walking, river transport, bus, helicopter, plane, bicycle, and the like.

For meeting participant selected in an individual one of fields 133, additional information, which may include social information, as well as explicit or implicit designations of criteria of interest, may be obtained from a previously stored profile by selecting one of use participant's profile check boxes 141, which includes participant's profile check boxes 141-1 through participant's profile check boxes 141-N. Exemplary social information may include information such as that a person is a vegetarian or observes kosher dietary laws, that a person needs a child-friendly venue, or that a person is wheel-chair bound and requires handicapped accessible facilities. Such social information would be relevant in selecting an appropriate venue. For example, if the venue, as selected in meeting venue section 108 is a restaurant, and the person is a vegetarian, a restaurant that has vegetarian selections would be appropriate. This may be achieved by deriving an implicit designation of criteria of interest for a vegetarian selection. The profile may also include limitations on general traveling ability, e.g., a person can't drive at night, becomes seasick when traveling by boat, or can't travel to a certain location, such as a state or country, for various legal reasons.

Exemplary explicit criteria of interest may include: minimization of travel time, minimization of cost, and minimization of distance. A user's designation of such criteria as being criteria of interest may be stored in the user's profile.

Those of ordinary skill in the art will readily be able to use conventional techniques such as forms with drop down boxes or interactive queries to develop appropriate profiles.

Optionally, each user may specify how interested he is in any criterion by assigning it a weight, e.g., using a scoring system, where for example, an essential interest is weight with a value of 1, a moderate interest is weighted with a value of 0.67, a minimal interest is weighted with a value of 0.33, and no interest is weighed with a value of 0. The implementer is not limited to values between 0 and 1 or 4 levels but rather may selected any weighting values is desired.

Meeting time specification area 105 allows for the user to select a proposed particular date and time for the meeting. Date 151, as indicated by label 153, is a field that allows the user to specify a date for the meeting being scheduled. This may be implemented by a text field into which the user may enter a particular date or by the use of any conventional so-called “pop-up calendar”. Time 155 is a field, as indicated by label 157, that allows the user to specify a time for the meeting being scheduled. This may be implemented by a text field into which the user may enter a particular date or by the use of any conventional so-called “pop-up clock”.

Optimize on section 107 is used to specify criteria of interest for meeting participants who do not have a user profile or to override information obtained from a user's profile. Label 171 indicates the general function of the section, namely optimize on. Each of various labels 195-1 through 195-N, collectively, labels 195, indicate the various types of criteria that may be designated as a criterion of interest for a particular meeting participant. Such designation is made by the user by clicking on the name of the meeting participant in one of criterion designation boxes 193-1 through 193-N, collectively, criterion designation boxes 193.

Each of criterion designation boxes 193 may be a multi-select box. When the user “clicks” on a meeting participant's, that name has its selection status reversed, where highlighting of the name indicates it is selected. When use of a meeting participant's profile is selected by checking one of use participant's profile boxes 141, any criteria of interest designated is set and the participant's name is highlighted in the corresponding ones of criterion designation boxes 193. The profile's settings may then be overridden by clicking on the user's name in any of designation boxes 193 for which it is desired to override the profile's settings. It is also possible to designate a criteria as being of interest to all of the meeting participants by selecting ALL in the appropriate one of designation boxes 193.

Optional meeting venue section 108 is used to specify a type of venue at which the meeting should be held. Label 181 indicates the general function that is to be selected, namely meeting venue. Field 183 lists various some possible choices that are available at which the meeting may be held, e.g., a hotel, a company location, an office, a restaurant, a bar, a public meeting place, a hall, e.g., wedding or party hall, or pool. Other exemplary venues not listed, include: a beach, a park, the house of one of the participants, a theater, a particular movie to be viewed, bowling alley, golf course, church, synagogue, mosque, temple, or the like. Furthermore, when selecting a particular item such as restaurant, a further menu may be opened to allow the user to specify a particular type of restaurant, e.g., an overall type of cuisine, a prescribed star rating, or the availability of a prescribed option on the menu, e.g., a vegetarian selection. Similarly, further menus may exist for 1) hotel, with choices such as conference room, ballroom or lobby; company location, with choices such as conference room, a particular office, cafeteria, or board room; church, with choices listing specific denominations; synagogue, with choices listing orthodox, conservative, or reform. One of ordinary skill in the art will readily recognize the plethora of possible venue categories and subchoices therefore that may be further selected. Multiple possible venues may be selected, using conventional multiple selection techniques. Alternatively, the type of meeting may be selected, e.g., business meeting, family gathering, pool party, beach party, bowling tournament, golf outing, dinner, and the like, and the system will select one or more appropriate meeting venues based on the known requirements for each such selectable meeting type.

Acceptance area 111 includes submit button 113 and reset button 115. When a user selects submit button 113, her choices are recorded and the system begins to determine an appropriate meeting place, and optionally, directions for each meeting participant to the determined meeting place. Should the user select reset button 115, all her existing choices are cleared from the frame.

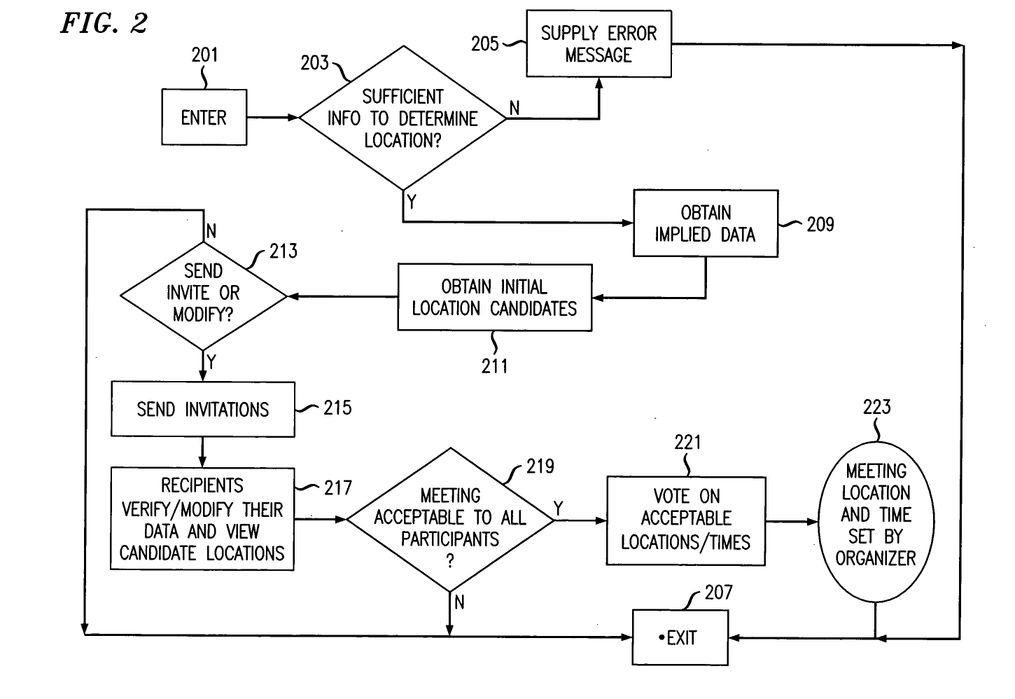

FIG. 2 shows a flowchart representing an exemplary process for selecting a meeting location that is “fair” to all the participants in accordance with the principles of the invention. The process is entered in step 201 after a user fills the information relevant to the desired meeting into exemplary page 100 and clicks on submit button 113. The information supplied by the user is supplied to a processor, which may be local to or remote from the user in order to develop the meeting location. For example, in one embodiment of the invention, the information may be supplied to a remote server (not shown) in accordance with the conventional processing of web-based forms.

Next, in conditional branch point 203, the process tests to determine if the user has supplied sufficient information to determine a meeting location, i.e., are at least two distinct meeting participants identified and the necessary information, such as location, mode of transport, date, time, etc. has been specified. Note that with regard to various pieces of information that are not directly provided by the user, e.g., the current location or the particular individuals that make up a selected group, these may be obtained by the system either directly or from an agent acting on behalf of the system, the particular participant or an agent thereof, such as a calendar or other digital assistant, or the user. To minimize the likelihood of errors, default values for each field may be specified that are supplied by the form unless the user changes them. Such default values may be initially selected by the programmer, but may be made customizable on a per-system, or even per-user, basis.

If the test result in step 203 is NO, indicating that the user has not supplied sufficient information to determine a meeting location, control passes to step 205, which causes an error message to be displayed to the user as well as causing exemplary page 100 to be redisplayed. Thereafter, control passes to step 207 and the process is exited.

If the test result in step 203 is YES, indicating that the user has supplied sufficient information to determine a meeting location, control passes to step 209, in which various pieces of data that have been specified by the user but not specifically identified are obtained. For example, if the user specified a group, e.g., Group 1, as being meeting participants, information for the particular individuals that make up the group is obtained. Similarly, if the user specified the current location of an individual, the current location of that individual represented by geographic information, e.g., coordinates, are obtained.

Control then passes to step 211, which determines a set of at least one candidate location, e.g., using the multi-criterial approach described hereinbelow, as well as, optionally, other pertinent information, such as route information or recommended travel start times for one or more meeting participants. A recommended meeting start time, which may not be the same as the start time selected originally on page 100, may also be supplied, e.g., if the originally selected start time turns out to not be available to all participants. This information is supplied to the meeting organizer, and control passes to conditional branch point 213, in which the meeting organizer determines, based on the received candidate locations, if it is desired to invite the participants to the meeting. If the test result in step 213 is NO, indicating that the meeting organizer is not satisfied with any of the candidate meeting locations, control is passed to step 207 and the process is exited in a manner that causes exemplary page 100 to be redisplayed so the meeting organizer can change the supplied information in the hopes of obtaining at least one satisfactory candidate location. If the test result in step 213 is YES, indicating that the meeting organizer is satisfied with the candidate meeting locations, control passes to step 215, in which invitations to the meeting, e.g., emails, text messages, voice messages, or the like, are sent to intended participants.

In step 217, the intended participants review the proposed meeting information, including the candidate meeting locations, and in response thereto, modify their information, such as availability and location information, if necessary, e.g., by updating their calendar or supplying the information to the meeting organizer to input it into the system via page 100. It may be necessary to do so if a user's availability or his anticipated location before the meeting has changed but this updated information was not available to the meeting optimizer.

Thereafter, control passes to conditional branch point 219, which tests to determine if the candidate meeting, e.g., locations and corresponding start times, are acceptable to all of the intended participants. If the test result in step 219 is NO, indicating that at least one intended participant has declined the meeting, provided updated information, or no responses are received within a prescribed timeout window, which may be a system default time, control passes to step 207 and the process is exited in a manner that causes exemplary page 100 to be redisplayed so that the meeting organizer can change the supplied information in the hopes of obtaining at least one candidate location that is satisfactory to all the intended participants. If the test result in step 219 is YES, indicating that the candidate meeting locations are acceptable to all the intended participants, control passes to optional step 221 in which the intended participants can provide input as to which of the candidate locations they would like to actually have the meeting at. This may be achieved by having each of the participants vote for a preferred location. Control then passes to step 223, in which the meeting organizer sets the meeting to be at one of the candidate locations, and informs the participants of that location. The process then exits in step 207.

Various approaches may be employed to determine the candidate meeting locations in step 211. For example, when the number of candidate locations is small, e.g., when the meeting is desired to be held at a company location or a major league baseball park, an exhaustive search method, e.g., one that tests all possible routes, may be employed, since the number of routes is likely to be relatively small. For example, to determine a location for a meeting for with 20 participants at a company location where the company has 10 locations, at least 200 possible routes need to be evaluated. The evaluation may be based on the one criteria of interest for which All is selected in optimization type 171, with no other criteria being selected for any participant, and the company location that best meets that evaluation is selected. In the event of a tie, more than one candidate may be presented.

In accordance with an aspect of the invention, the problem of determining the meeting location may be solved using a multi-criterial approach that may explicitly take into account the fact that a) each user has to deal with several criteria, which are often contradictory, such as time to travel and cost of travel; and b) the criteria of different users, unless they are colocated, are contradictory on the part of the optimization domain situated “between” the users. In the multi-criterial approach, one selects a preference relation based on the individual criteria, and the set of non-dominated alternatives is the outcome of the optimization process that provides suitable choices of meeting locations to the user. Advantageously, additional flexibility is provided by taking into account the contradictory character of the criteria, since it is not necessary to aggregate all the criteria into a single optimization function. Further advantageously, the result of the optimization procedure is intrinsically a set, rather than a single element. Thus, unlike selecting several best ranked variants with respect to optimization of a single functional, the set of non-dominated variants reflects the available range of alternatives that fairly accommodate the conflicting criteria.

In this regard, R is defined as a preference relation on a set of alternatives X as a subset of X×X, interpreted as a preferred to b if and only if (a, b) is in R, such that R is transitive and asymmetric. The non-dominated alternatives are defined as the elements a of X such that for no b in X, b is preferred to a. Then, if f₁, f₂, etc., are each some criteria, the Pareto preference relation can be formed by requiring a is preferred to b if and only if fᵢ(a)≧fᵢ(b) for all i, with at least one inequality strict. More generally, some linear functions of fᵢ's can be taken and used to form preference relations like Pareto preference relations using these linear functions as the primary inputs. Nonlinear monotone functions can also be employed as the primary inputs.

The basic problem for selecting the meeting location is solved as an Integer Programming model

$${min}_{{x}_{i} ∈ \{ 0 , 1 \}} \{ C ( {x}_{1} , {x}_{2} , … , {x}_{I} ) \vert {\sum }_{i = 1} {x}_{i} = 1 , ( {x}_{1} , … , {x}_{I} ) ∈ X \} \qquad ( 1 )$$

where I is the set of potential meeting places, xᵢ is a decision variable that equals 1 if site i is selected and 0 otherwise. The locations within set I are determined based on the meeting venue selected in meeting venue 181 of form 100 as applied to a source of information, e.g., a database, having information about all known possible meeting locations. Such sources of information are well known and commercially available. Having the sum over all xᵢ equal to 1 indicates that at most one location should be selected.

The constraint set X may be used to impose additional constraints and goals on the choice of xᵢ(i=1, . . . , I). For instance, implementing the requirement that xᵢ should be a location that is reachable by any participant within some time limits can be achieved by constraining X into a subspace of [0, 1]^{I} in which all xᵢ that do not satisfy this condition have a value of 0.

Model (1) can be solved in many different ways. One approach is to express the model in AMPL format and feed both the model and data into a standard integer programming package such as CPLEX. Alternatively, one could implement the algorithm from scratch, using standard integer programming techniques or even enumeration.

The problem can be made more general by considering that the decision-makers are concerned not only by one simple objective function C(x₁, x₂, . . . , x_{I}), but rather by multiple objectives Cₖ(x₁, x₂, . . . , x_{I}), k=1, . . . , K. This extension can be addressed in several ways. One possibility is to select one objective to optimize while imposing constraints on others to meet some acceptable performance levels, i.e.,

$${min}_{{x}_{i} ∈ \{ 0 , 1 \}} \{ \begin{matrix}{C}_{{k}^{′}} ( {x}_{1} , {x}_{2} , … , {x}_{I} ) \vert {\sum }_{i = 1} {x}_{i} = 1 , ( {x}_{1} , … , {x}_{I} ) ∈ X , \\ {C}_{k} ( {x}_{1} , {x}_{2} , … , {x}_{I} ) \geq {\overline{C}}_{k} , k = 1 , … , K , k \neq {k}^{′}\end{matrix} \}$$

Alternatively, the weighted sum of all objectives,

$${\sum }_{k = 1}^{K} {w}_{k} {C}_{k} ( {x}_{1} , … , {x}_{I} ) ,$$

can be maximized or the minimum of all weighted objectives,

$${min}_{k = 1 , … K} {w}_{k} {C}_{k} ( {x}_{1} , … , {x}_{I} ) ,$$

where wₖ, k=1, . . . , K are weights, or the minimum excess over some given threshold

$${min}_{k = 1 , … K} \{ {C}_{k} ( {x}_{1} , … , {x}_{I} ) - {t}_{k} \} ,$$

where tₖ, k=1, . . . , K are thresholds, may be determined. In these cases, the methods as described above, i.e., AMPL+CPLEX, are employed to solve the reformulated integer programming model. An exemplary AMPL code addressing this last variant is shown in Table 1.

Note that prior to executing the code of Table 1, it is first necessary to preprocess the user profile and the criteria to obtain the particular values for all of the criteria. Remember each criterion has a name. Each criterion may assume a different value depending on which candidate location is processed. Each criterion is unique to a meeting participant.

```
TABLE 1
#  CRITERIA is the set of names of the criteria of interest
# LOCATIONS is the set of names of locations that meet the venue
specified
#  herein it is assumed that the matrix evals contains
#  the evaluations of the locations with respect to criteria of interest
# importance is a nonzero default value that is the same for each criteria
# of interest unless modified by a user preference or system policy
set CRITERIA;
set LOCATIONS;
param evals{CRITERIA, LOCATIONS};
param importance{CRITERIA}>0;
var x{LOCATIONS}>=0;
var ideal{CRITERA};
for j in CRITERIA {
maximize best:
  sum {k in LOCATIONS} evals(j,k)*x(k);
subject to convex{LOCATIONS}:
  sum {k in LOCATIONS} x(k)=1;
let ideal(j):=best;
}
var w{CRITERIA,LOCATIONS}>=0;
maximize y;
subject to bound{k in LOCATION}:
  sum {j in CRITERIA}w(j,k)*(ideal(j)−y*importance(j)−evals(j,k))>=0;
subject to weights{k in LOCATIONS}:
  sum {j in CRITERIA} w(j,k)=1;
let best_loc:=sum {k in LOCATIONS} sign(bound(k))*k;
```

Another way to handle this issue is to generate the efficient set of all viable choices from which a solution can be selected by the meeting participants, e.g., via voting, as in step 221 of FIG. 2. The collection of all non-dominated solutions, i.e., the solution that out-performs any other solution on at least one objective, is considered as the efficient set. The set can be created by executing the steps in the following loop
1. Let the entire set of solution be the efficient set.
2. Going through every solution in the set, one at a time, and compare its performance on every objective with every other solution remaining in the set.
3. If there is one other solution that is as good as the solution to be compared on every objective, then the latter is eliminated from the efficient set.
4. The process ends and the remaining solution is given as the final efficient set when all solutions have been compared.

Once a set of candidate locations have been selected using a multi-criterial approach, they may be further narrowed using a conventional single criterion approach. To this end, a final, arbitrative criterion is selected, which may be one of the previously employed criteria, and the best location from amongst the candidate locations is selected based on the arbitrative criterion.

In the event that unanticipated conditions arise as one or more of the participants are traveling to the meeting, the system may be employed to automatically select an alternative location for the meeting that has become “fairer” than the originally selected meeting location and present it for approval by the participants. One such unanticipated condition may be where one of the intended participants can no longer attend the meeting. Another possible unanticipated condition may be severe traffic congestion, e.g., due to a traffic accident.

Note that, in accordance with an optional feature of the invention, some of the designated meeting participants may be declared essential, with the remained being deemed to be optional. Such essential users may be designated through the use of checkboxes regarding essentiality that are added to page 100. According to such a feature, one or more of the specified criteria of interest to the optional participants may be ignored, so as to arrive at a set that has a location that is fair to the essential participants even if it is unfair to one or more of the optional participants. For example, this may be desirable in the event that a suitable location and time cannot be found for all of the proposed meeting participants. Alternatively, after the candidate locations are determined, the meeting participants designated as optional are not permitted to vote on acceptable locations or times.

What is claimed is:

1. A method for developing a meeting location for a plurality of meeting participants, comprising the steps of:
determining the travel circumstances of each of said meeting participants; and
selecting a set of candidate meeting locations such that each of said meeting participants has a fair travel burden to each of said candidate meeting locations based on a plurality of initial criteria, at least one of said initial criteria having values that are determined for an associated one of said meeting participants using at least information derived from said travel circumstances.

2. The invention as defined in claim 1 wherein said determining step further comprises the step of obtaining information that characterizes said meeting participants.

3. The invention as defined in claim 2 wherein said information that characterizes said meeting participants comprises at least one of the set consisting of: (i) starting travel location, (ii) available travel time, (iii) available modes of transportation, (iv) social limitations of the participant, and (v) personal limitations of the participant.

4. The invention as defined in claim 1 wherein said determining step further comprises the step of obtaining information about the environment through which said meeting participants would have to travel to reach a location if that location is selected as the meeting location.

5. The invention as defined in claim 4 wherein said information about the environment through which said meeting participants would have to travel comprises at least one of the set consisting of (i) time to travel between the starting location and the candidate location, and b) cost of travel between the starting location and the candidate location.

6. The invention as defined in claim 1 further comprising the step of selecting a meeting location from said set of candidate meeting locations based on a specified final arbitrative criteria.

7. The invention as defined in claim 1 wherein one of said initial criteria is a prescribed meeting venue type.

8. The invention as defined in claim 1 wherein a travel burden is fair to one of said meeting participants when such burden cannot be decreased without increasing the burden of another of said meeting participants beyond a prescribed significance threshold.

9. The invention as defined in claim 1 wherein said initial criteria by which said meeting location will be selected comprises at least one criterion of the set consisting of: (i) maximum travel time for one or more participant, (ii) total travel time by all participants, (iii) total distance traveled by all participants, (iv) the maximum distance traveled by any single participant, (iv) the financial expenses incurred to get the participants to the location

10. The invention as defined in claim 1 wherein in said selecting step a preference relation is defined based on said initial criteria and said set of candidate meeting locations is based on a set of non-dominated potential meeting locations given said preference relation.

11. A method for selecting a meeting location for a plurality of meeting participants, comprising the steps of:
determining at least one initial criterion of interest for each at least two of said plurality of meeting participants; and
selecting a set of fair candidate meeting locations based on a set of at least two objectives that are a function of said criteria.

12. A method for selecting a meeting location for a plurality of meeting participants, comprising the steps of:
determining a venue for said meeting, said venue being a criterion for said meeting;
for at least one meeting participant, determining at least one initial criterion of interest; and
selecting a set of fair meeting locations based on at least said venue and said at least one initial criterion of interest.

13. A method for selecting a meeting location for a plurality of meeting participants, comprising the steps of:
obtaining a first criterion for said meeting, said first criterion being a venue for said meeting;
obtaining a second criterion for said meeting, said second criterion being at least one initial criterion of interest for at least one meeting participant; and
determining a set of candidate fair meeting locations based on at least said first and second criteria.

14. A method for selecting a meeting location for a plurality of meeting participants, comprising the steps of:
obtaining a first initial criterion of interest for a first of said plurality of meeting participants;
obtaining a first initial criterion of interest for a second of said plurality of meeting participants; and
determining a set of candidate fair meeting locations based on at least said first initial criterion of interest for said first of said plurality of meeting participants and said first initial criterion of interest for said second of said plurality of meeting participants.
